(19) United States
(12) Patent Application Publication
(10) Pub. No.: US 2014/0183841 A1
(43) Pub. Date: Jul. 3, 2014

(54) Tow Hitch System with Brake Sensor

(71) Applicant: Dustin Jones, Elgin, TX (US)

(72) Inventor: Dustin Jones, Elgin, TX (US)

(21) Appl. No.: 14/136,468

(22) Filed: Dec. 20, 2013

Related U.S. Application Data
(60) Provisional application No. 61/745,075, filed on Dec. 21, 2012.

(51) Int. Cl. B60W 10/30; B60W 10/184

(52) U.S. Cl. CPC B60W 10/30; B60W 10/184
USPC 280/446.1

(57) ABSTRACT

Sensors detect movement between a towing vehicle and a load and adjust braking forces proportionately to the movement.

### CROSS-REFERENCE TO RELATED APPLICATIONS

The present application is a continuation-in-part of, claim priority from and the benefit of United States provisional application serial number, filed Dec. 21, 2013 byt the same inventor and having the same title, the disclosure of which is incorporated herein by reference.

### TECHNICAL FIELD

This disclosure relates generally to tow hitches and more particularly to an improved tow hitch having sensors to improve braking when towing a load.

### SUMMARY

Sensors detect movement between a towing vehicle and a load and adjust braking forces proportionately to the movement.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an isometric diagrammatic illustration of an exemplary embodiment of a towing system of the present disclosure.

FIG. 2 is an isometric diagrammatic illustration of a detail of the towing system of FIG. 1.

FIG. 3 is an isometric diagrammatic illustration of an exemplary embodiment of a tow ball of the present disclosure.

FIG. 4 is a bottom view horizontal cross section of the tow ball of FIG. 3.

FIG. 5 is an isometric diagrammatic illustration of an exemplary embodiment of a tow arm of the present disclosure.

FIG. 6 is a cross section detail of the sensor box of the tow arm of FIG. 5.

FIG. 7 is a diagrammatic illustration of an alternative exemplary embodiment of the towing system of FIG. 1 utilizing an optical sensor.

FIG. 8 is a diagrammatic illustration of an alternative exemplary embodiment of the towing system of FIG. 1 utilizing a pressure sensor.

FIG. 9 is a diagrammatic illustration of an alternative exemplary embodiment of the towing system of FIG. 1 utilizing dual sensors.

FIG. 10 is a diagrammatic illustration of an alternative exemplary embodiment of the towing system of FIG. 1 utilizing a magnetic sensor.

FIG. 11 is a diagrammatic illustration of an alternative exemplary embodiment of the towing system of FIG. 9 utilizing an alternative embodiment of a magnetic sensor.

FIG. 12 is a diagrammatic illustration of an alternative exemplary embodiment of the towing system of FIG. 1 utilizing a strain gauge sensor.

FIG. 13 is a diagrammatic illustration of an alternative exemplary embodiment of the towing system of FIG. 1 utilizing a strain sensor.

### DETAILED DESCRIPTION

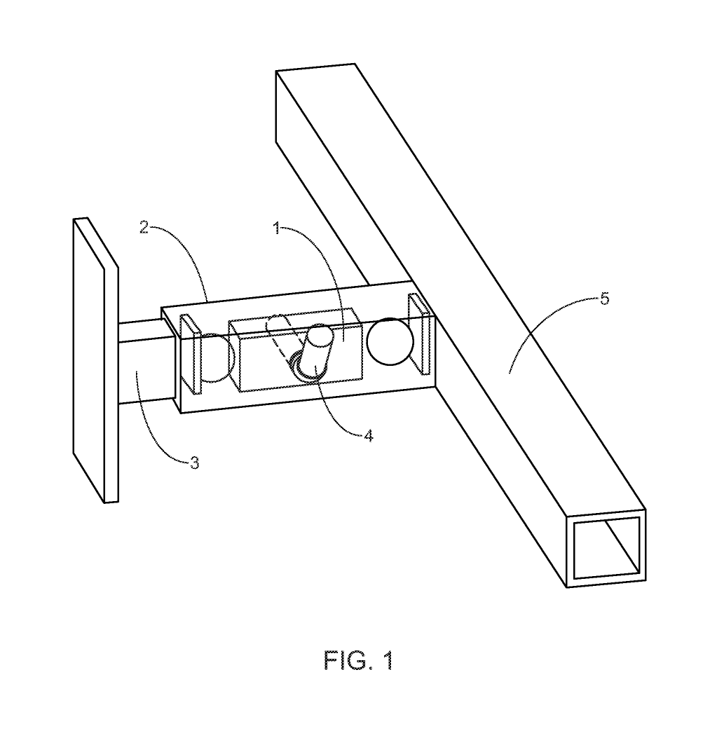

Referring to FIG. 1 of the drawings, FIG. 1 is an isometric diagrammatic illustration of an exemplary embodiment of a towing system of the present disclosure. As the trailer member 3 moves to the right, it moves the inner member 1, with respect to the outer member 5 which is attached to the towing vehicle. As the member 1 moves into the member 2 the pin 4 stops the movement of the inner member 1, and there is a displacement between the inner member 1 and the outer member 2.

As the member 1 moves out of the member 2, the pin 4 stops the movement of the inner member 1 and there is a displacement between the inner member 1 and the outer member 2 in the opposite direction. This displacement can be measured by use of a Hall effect sensor.

A Hall effect sensor is a transducer that varies its output voltage in response to a magnetic field. Hall effect sensors are used for proximity switching, positioning, speed detection, and current sensing applications.

In its simplest form, the sensor operates as an analog transducer, directly returning a voltage. With a known magnetic field, its distance from the Hall plate can be determined. Using groups of sensors, the relative position of the magnet can be deduced.

Electricity carried through a conductor will produce a magnetic field that varies with current, and a Hall sensor can be used to measure the current without interrupting the circuit. Typically, the sensor is integrated with a wound core or permanent magnet that surrounds the conductor to be measured.

Frequently, a Hall sensor is combined with circuitry that allows the device to act in a digital (on/off) mode, and may be called a switch in this configuration. Commonly seen in industrial applications, they are also used in consumer equipment. Hall sensors are commonly used to time the speed of wheels and shafts, such as for internal combustion engine ignition timing, tachometers and anti-lock braking systems.

The sensor of the exemplary embodiment of FIG. 1 outputs a voltage of 2.35v when there is no net magnetic field perpendicular to the face of the sensor. As the magnetic field increases in one direction, the voltage increases proportionally. As the magnetic field increases in the opposite direction, the voltage drops proportionally.

Two magnets are mounted to the inside of the insert tubing of the member 3, so that when the trailer member 3, is in a neutral position with respect to the towing element, the sensor lies between the two magnets. The sensor is mounted to the inner element, made of non-magnetic material.

As the trailer member moves to the right during braking, the magnets are moved to the left with respect to the inner member 1. This causes the magnetic field through the sensor to increase in one direction and is sensed by the Hall sensor.

A micro controller reads the output of the Hall sensor, and outputs to the brakes of the trailer a PWM (Pulse Width Modulated) signal proportional to the relative displacement. Mild braking of the pulling vehicle will produce a mild braking of the trailing vehicle. Aggressive braking of the pulling vehicle will produce aggressive braking of the trailing vehicle. And appropriate braking of the trailer will be produced regardless of the weight of the trailer, or its load.

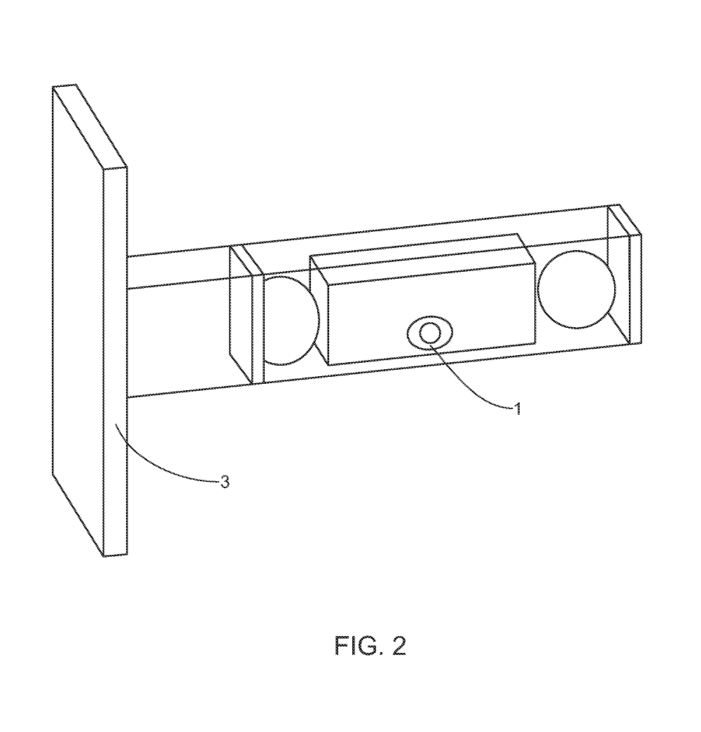

FIG. 2 is an isometric diagrammatic illustration of a detail of the towing system of FIG. 1. Aperture 1 receives pin 4 (from FIG. 1).

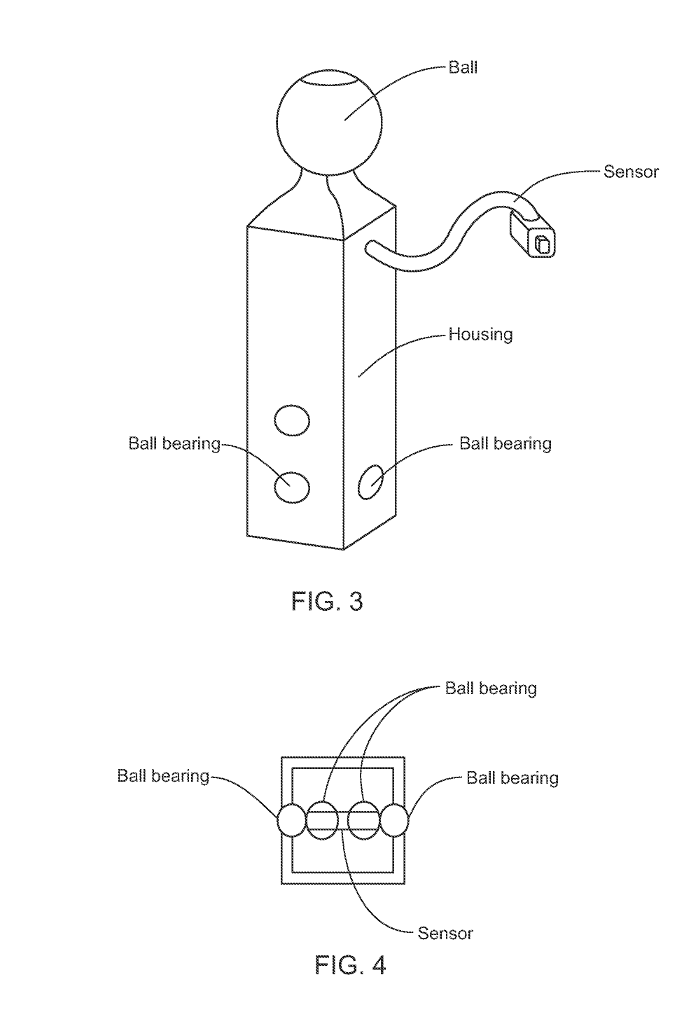

FIG. 3 is an isometric diagrammatic illustration of an exemplary embodiment of a tow ball of the present disclosure. A towing ball is disposed on a housing. Ball bearings are mounted in apertures provided in the housing. A sensor wire exits the housing from a sensor wire aperture in the housing.

FIG. 4 is a bottom view horizontal cross section of the tow ball of FIG. 3. Ball bearings mounted in the housing are proximate to magnets disposed in the interior of the housing. Each ball bearing is proximate to a corresponding magnet. Disposed between the magnets is a sensor that is connected to the sensor wire of FIG. 3.

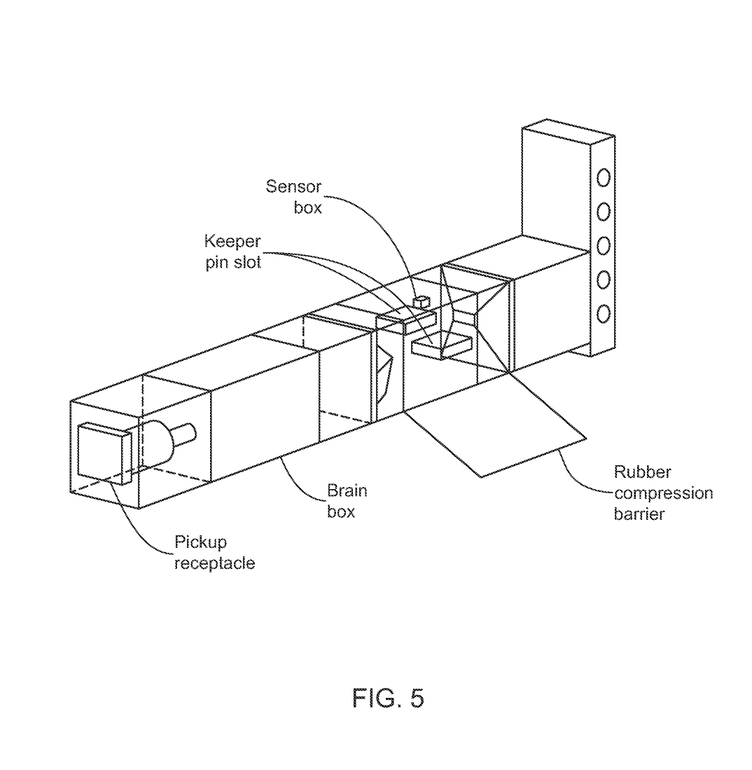

FIG. 5 is an isometric diagrammatic illustration of an exemplary embodiment of a tow arm of the present disclosure. The tow arm corresponds to member 2 of FIG. 1. Sections of member two are depicted as transparent to illustrate the interior components. The sensor box is mounted in member 2 proximate to the pin slot. A sensor pickup is mounted in member 2 distal from the sensor box. A controller such as a microchip or computer is housed in member 2 between the pickup and sensor box. Specific exemplary embodiments provide a rubber compression barrier.

FIG. 5 is a cross section detail of the sensor box of the tow arm of FIG. 5. The sensor box is mounted to solid backing plates on opposite side. Compression brushings are disposed between the backing plates and the sensor box and the keeper pin slot (aperture) traverses through the sensor box.

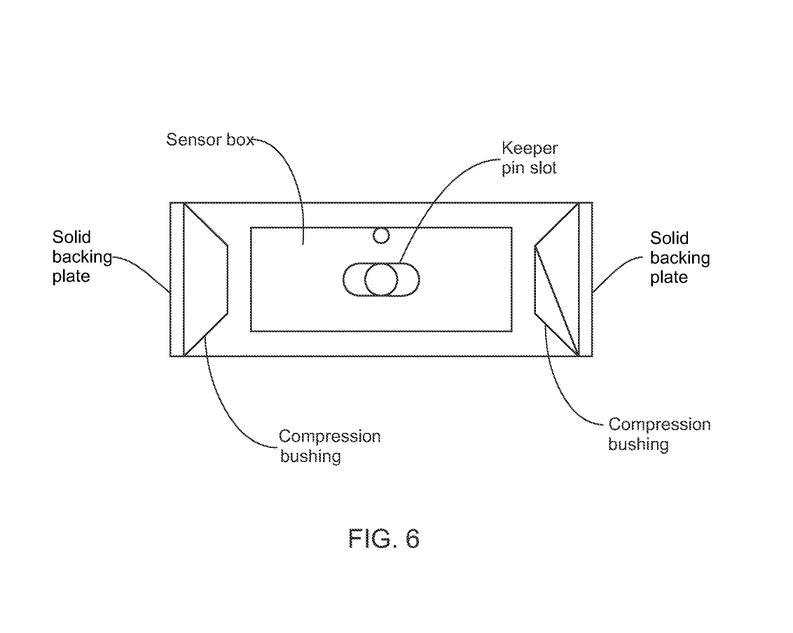

FIG. 6 is a diagrammatic illustration of an alternative embodiment of the towing system of FIG. 1 utilizing an optical sensor. A hole or aperture is provided through both components 1 and 3. A light sensor is mounted on one side and a light source on the other side. As component 1 moves with respect to component 3 the light path is obstructed and less light falls on the sensor and voltage increases.

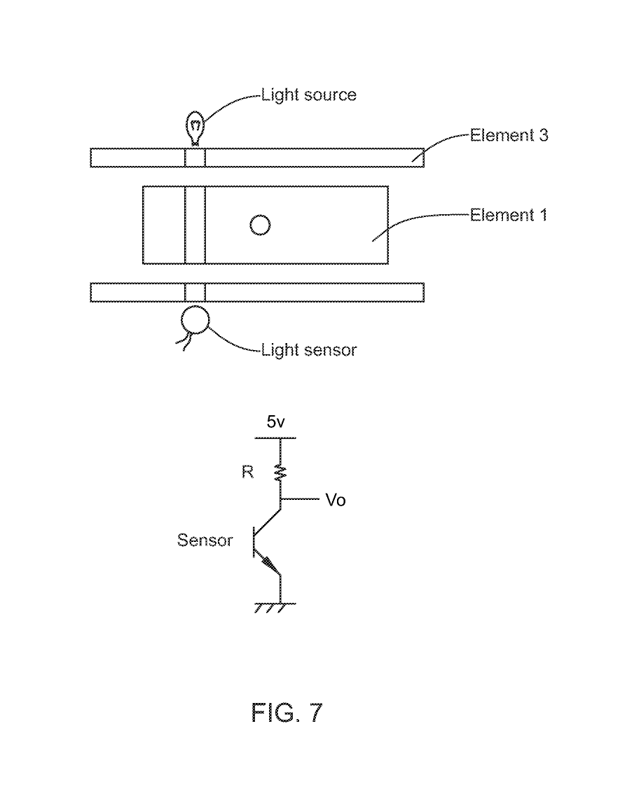

FIG. 7 is a diagrammatic illustration of an alternative embodiment of the towing system of FIG. 1 utilizing a pressure sensor. A pressure sensor is placed at each end of member 1. The spheres are elastic. As member 1 moves to the right pressure is increased on the sensor to the right and decreased on the sensor to the left. Electrical resistance in the right sensor decreases and the voltage increases. The response is reversed when member 1 moves to the left.

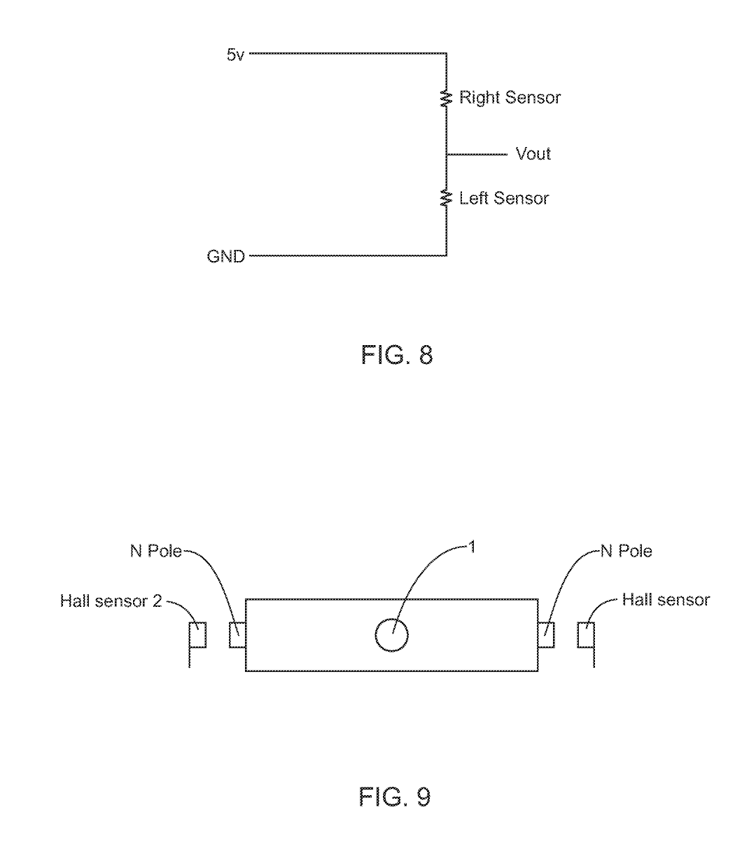

FIG. 8 is a diagrammatic illustration of an alternative embodiment of the towing system of FIG. 1 utilizing dual sensors. A first Hall sensor is fixed at one end of member 3 and a second Hall sensor is fixed at the other end of member 3. As member 1 moves to the right, first Hall sensor output signal increases and second hall sensor output signal decreases, and vice versa when member 1 moves to the left.

FIG. 9 is a diagrammatic illustration of an alternative embodiment of the towing system of FIG. 1 utilizing a magnetic sensor. A hall sensor is disposed between the north poles of two magnets. As the Hall sensor moves to the right, more north pole force is felt by the right face of the sensor, changing the sensor output signal. As the sensor moves left, more north pole forces are felt by the left face of the sensor, changing the sensor output signal.

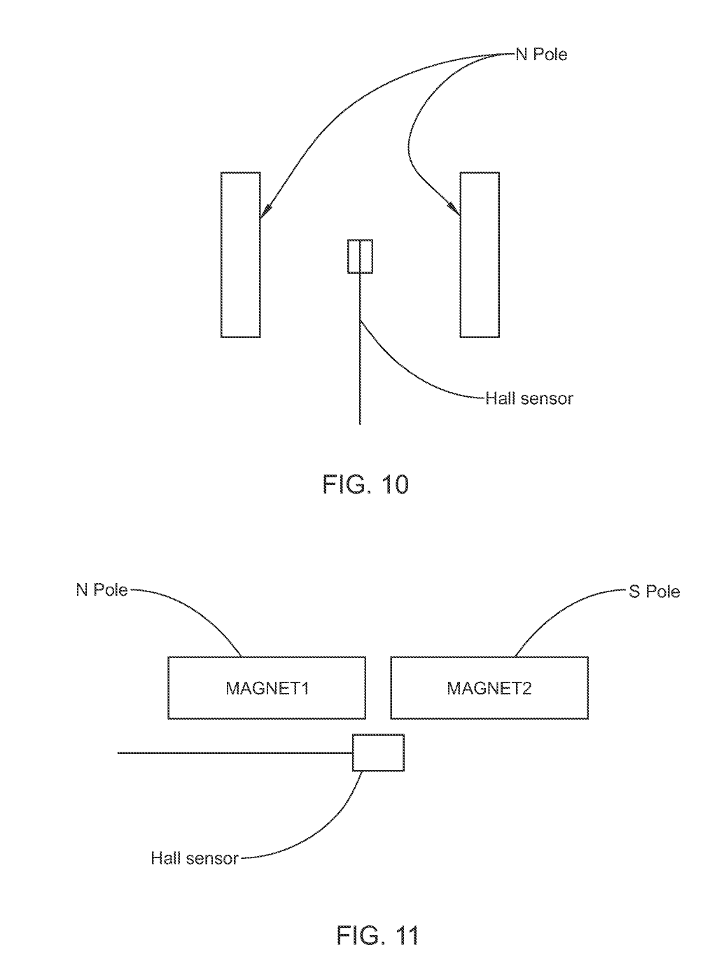

FIG. 10 is a diagrammatic illustration of an alternative embodiment of the towing system of FIG. 9 utilizing an alternative embodiment of a magnetic sensor. A Hall sensor is disposed between two magnets that are concatenated north pole to south pole. As the sensor moves right, more south pole forces are felt by the sensor, changing the sensor output signal. As the sensor moves left, more north pole forces are felt by the sensor, changing the sensor output signal.

FIG. 11 is a diagrammatic illustration of an alternative embodiment of the towing system of FIG. 1 utilizing a strain sensor. A strain gauge is disposed between member 1 and member 3. As member 1 moves in relation to member 3, the strain gauge output changes proportionately with increased or decreased output signal.

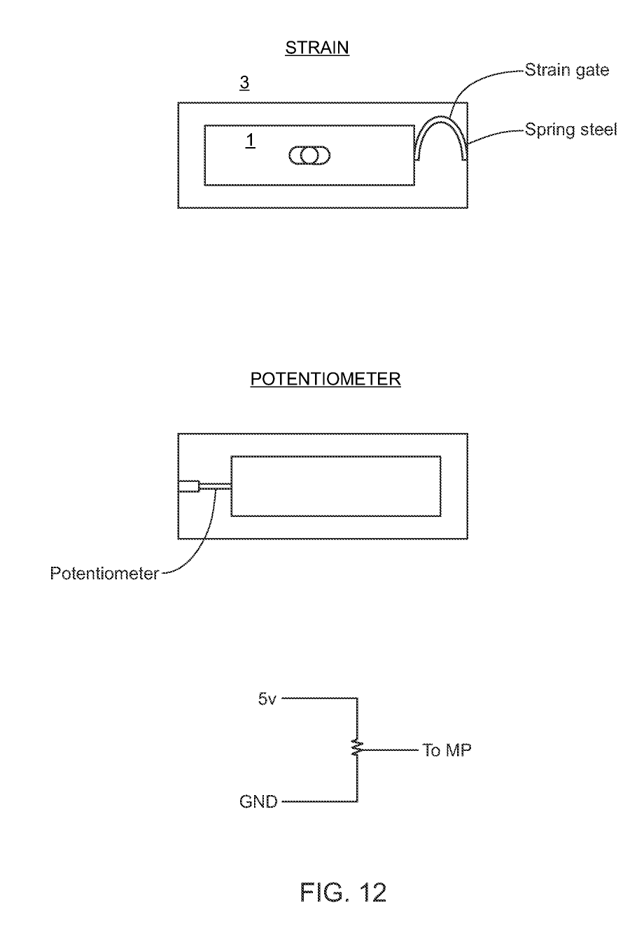

FIG. 12 is a diagrammatic illustration of an alternative exemplary embodiment of the towing system of FIG. 1 utilizing a strain gauge sensor. A U-member, for example, connected to a sensor and disposed between the load tow hitch member and the vehicle tow hitch member flexes or contracts as the load approaches or recedes from the vehicle. The sensor detects the strain on the U-member to adjust braking proportionately.

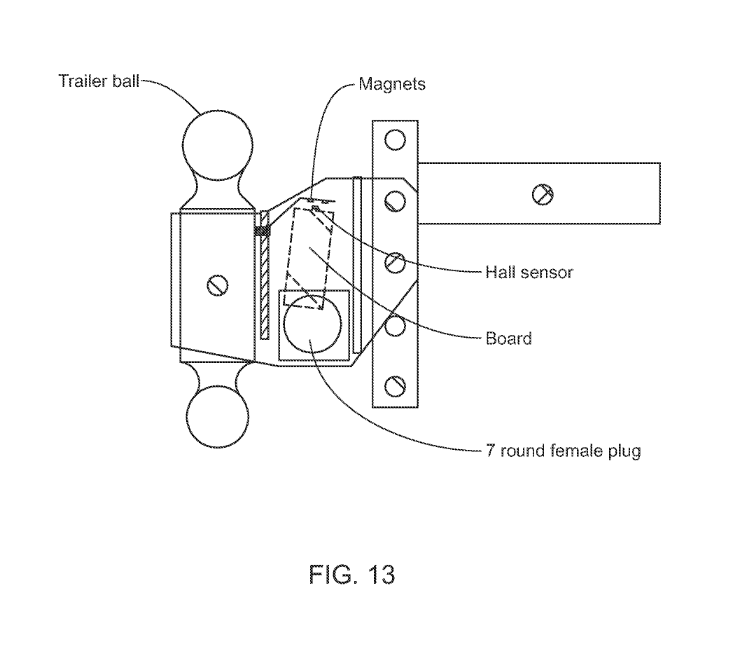

FIG. 13 is diagrammatic illustration of a specific alternative exemplary embodiment of a towing system of the present disclosure that provides a modular insert hitch with an integrated electronic controller.

The integrated modular hitch embodiment, for example, is described with reference to a truck and trailer by way of example and not limitation. An insert hitch having an integrated controller produces a result that can be applied to any receiver hitch simply by inserting the insert hitch into the receiver hitch of the truck and plugging the leads from the integrated controller into the truck and plugging the trailer into the hitch. Transportability from truck to truck is achieved with ease.

The hitch is modular in that it is adapted to be engageable with a variety of different types of receiver hitches. For example, the hitch can be modularly applied to goose neck hitches. Goose neck hitch integration yields similar advantages as the trailer hitch described above. To a lesser degree but still significant is the impact on the receiver hitch as it is applied to a truck.

The controller electronic technology enables the integration of the mechanical and the control functions in order to produce a unit that requires no installation of any unit into the cab of the truck and no interaction with the user. No training of the operator is required. No wires run to the truck except those already installed by the manufacturer. The only interface to the operator is a display mounted in the cab of the truck and connected to the controller by, for example, the brake wire, to display to the operator a verification that the brakes are active and how much. Alternative embodiments provide wireless transmission of data from the controller to the cab display. Additional alternative exemplary embodiments provide enhanced information to the cab display, such as providing a low tire warning.

In addition to the foregoing embodiments, the present disclosure provides programs stored on non-transient machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Many modifications and other embodiments of the tow system described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claim is:

1. A tow hitch that detects movement between a towing vehicle and a load and adjusts the braking forces of the load brakes proportionately to the movement, the hitch comprising:
a. a load tow member engageable with a vehicle tow member; and
b. one or more sensors connected to the load tow member such that at least one of the one or more sensors is disposed between the vehicle tow member and the load tow member when the load tow member is engaged with the vehicle tow member, wherein the at least one of the one or more sensors is in electronic communication with the load brakes, whereby the at least one of the one or more sensors senses movement between the load member and the vehicle member when the load tow member is engaged with the vehicle tow member and adjusts the braking forces of the load brakes proportionately to the movement.

2. The tow hitch of claim 1, wherein at least one of the one or more sensors is a pressure sensor.

3. The tow hitch of claim 1, wherein at least one of the one or more sensors is an optical sensor.

4. The tow hitch of claim 1, wherein at least one of the one or more sensors is a Hall sensor.

5. The tow hitch of claim 1, wherein at least one of the one or more sensors is a magnetic sensor.

6. The tow hitch of claim 1, wherein at least one of the one or more sensors comprises a strain gauge.

7. The tow hitch of claim 1, wherein the tow hitch is modular.

8. A tow hitch system that detects movement between a towing vehicle and a load and adjusts the braking forces of the load brakes proportionately to the movement, the hitch comprising:
a. a load tow member engageable with a vehicle tow member;
b. one or more sensors connected to the load tow member such that at least one of the one or more sensors is disposed between the vehicle tow member and the load tow member when the load tow member is engaged with the vehicle tow member, wherein the at least one of the one or more sensors is in electronic communication with the load brakes, whereby the at least one of the one or more sensors senses movement between the load member and the vehicle member when the load tow member is engaged with the vehicle tow member and adjusts the braking forces of the load brakes proportionately to the movement and
c. a controller integrated with at least one of the one or more sensors.

9. The tow hitch of claim 8, wherein at least one of the one or more sensors is a pressure sensor.

10. The tow hitch of claim 9, wherein at least one of the one or more sensors is an optical sensor.

11. The tow hitch of claim 10, wherein at least one of the one or more sensors is a Hall sensor.

12. The tow hitch of claim 11, wherein at least one of the one or more sensors is a magnetic sensor.

13. The tow hitch of claim 12, wherein at least one of the one or more sensors comprises a strain gauge.

14. The tow hitch of claim 13, wherein the tow hitch is modular.
